(19) United States
(12) Patent Application Publication
(10) Pub. No.: US 2004/0234811 A1
(43) Pub. Date: Nov. 25, 2004

(54) Energy-transfer type light-emitting polymer based on poly(p-phenylene vinylene) and preparation thereof

(76) Inventors: Lixiang Wang, Changchun City (CN); Honghao Sun, Changchun City (CN); Yanxiang Cheng, Changchun City (CN); Chongyu Mei, Changchun City (CN)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/777,896

(22) Filed: Feb. 13, 2004

(30) Foreign Application Priority Data
May 15, 2003 (CN) 03131075.3

(51) Int. Cl. B32B 19/00

(52) U.S. Cl. 428/690

(57) ABSTRACT

This invention relates to an energy-transfer type light-emitting polymers based on poly(p-phenylene vinylene)s containing two or more kinds of luminous elements which are completely isolated by an ether group in the backbone, having the following structural formula. The conjugated length of each kind of luminous element can be adjusted and different luminous elements can be effectively isolated by an ether bond as a linking element and an isolating element. Meanwhile, different luminous elements can independently emit, which provides the precondition of energy transfer between different luminous elements in relation to molecular structure and therefore the fluorescence quantum efficiency can be improved.

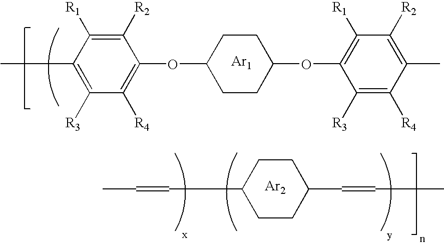

wherein Ar₁, Ar₂, R₁, R₂, R₃, R₄, x and y are defined as in claims.

### TECHNICAL FIELD

This invention belongs to the field of organic optoelectronic material and technique. Particularly, it relates to energy-transfer type light-emitting polymer based on poly(p-phenylene vinylene) and preparation thereof.

### BACKGROUND ART

In the field of polymeric electroluminescence, the development of highly efficient light-emitting polymers is the everlasting subject in the scientific research of material, and the effective way for improving the fluorescence quantum efficiency of light-emitting polymer is an unremitting goal of the international material scientists.

Since the electroluminescene of the conjugated polymer-poly(p-phenylene vinylene)(PPV) was reported in 1990 by Burroughs et al, Cambridge Univ., UK, the typical polymeric luminescent material systems, such as poly(p-phenylene) (PPP), polyalkylfluorene (PAF), poly alkylthiophene (PAT) have been developed in succession, the research and practicalizing courses of polymeric luminescent material have been promoted greatly.

The ways for improving fluorescence quantum efficiency of polymeric luminescent material mainly include, for example, warping the molecules to reduce their aggregation, wrapping the molecules to weaken their aggregation, and transferring the inner molecular energy to strengthen the luminescence. For example, a high efficiency green PPV polymeric luminescent material (luminous efficiency up to 10 cd/A) has been prepared by the method of warping molecules by H. Spreitzer et al (Adv. Mater., 10, 1340, 1998; PCT Patent Application, WO 98/27136, 1996); a blue molecule-isolated type polymeric luminescent material has been designed and synthesized, by using a side group of large size dendrimer as isolated group, by Schlueter et al (Angew. Chem. Int. Ed., 38, 2370, 1999; Macromolecules, 33, 2688, 2000); and a molecule-wrapping type polymeric luminescent material has been prepared by using large size cyclic compound as insulated molecular conductor, H. L. Anderson et al, Nature Materials, 1, 160, 2002. All these methods provide a new way for developing high efficiency polymeric luminescent material.

The intermolecular energy-transfer is an universal phenomenon of the polymeric electroluminescence, and generally results in quenching of SW (short-wave) luminescence, and intensifying of LW (long-wave) luminescence, i.e. results in transferring energy from SW luminescence to LW luminescence. Therefore, as an effective way fu; raising the fluorescence quantum efficiency of electroluminescent devices, it is widely used in preparing the blending type polymeric electroluminescent devices. Based on the fact that energy can be transferred between different emission components at a certain condition, we have developed one energy-transfer light-emitting polymers in which energy is transferred from main chain to side chain (Chinese Patent Application No.02116046.5) and one in which energy is transferred from side chain to main chain (Chinese Patent Application No.02118729.0) by co-polymerizing two different luminous elements onto the main chain and side chain of the polymer molecule, respectively. The above two applications were useful for developing high efficiency polymeric luminescent material. However, there is still a need for further improving the luminescent efficiency.

### SUMMARY OF THIS INVENTION

An object of this invention is to provide an energy-transfer type light-emitting polymer based on poly(p-phenylene vinylene)s with the improved liminescent efficiency;

Another object of this invention is to provide a process for preparing the energy-transfer type light-emitting polymer based on poly(p-phenylene vinylene)s.

In order to achieve the above objects, the present inventors studied diligently and thoroughly. As a result, it was found that the fluorescence quantum efficiency of a polymeric luminescent material can be greatly improved. That is, different luminous elements which are fully isolated by an ether bond are contained in a backbone of a poly(p-phenylene vinylene) polymer, thus making it possible that energy transfer happens between the different luminous elements in the backbone.

Thus, according to one aspect of the present invention, an energy-transfer type poly(p-phenylene vinylene) polymeric luminescent material is provided, which has the structural unit as represented by the, following formula (1):

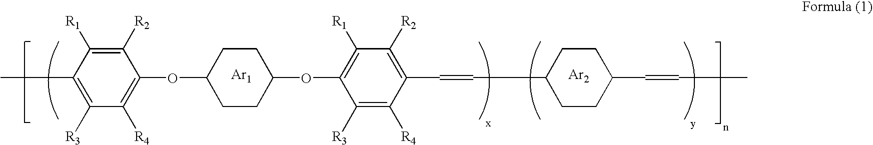

wherein R₁, R₂, R₃, and R₄ each independently is hydrogen, alkyl, alkoxy, optionally substituted phenyl or naphthyl; x and y each is the content of the luminous element, satisfying 0<x 1, 0 y<1, x+y=1; and n=1-200; Ar₁ being one or two structural luminous elements selected from a group consisting of formula (2)-formula (29), wherein R, R₁, R₂, R₃ and R₄ each independently is hydrogen, alkyl, alkoxy, optionally substituted phenyl or naphthyl; m=1-10;

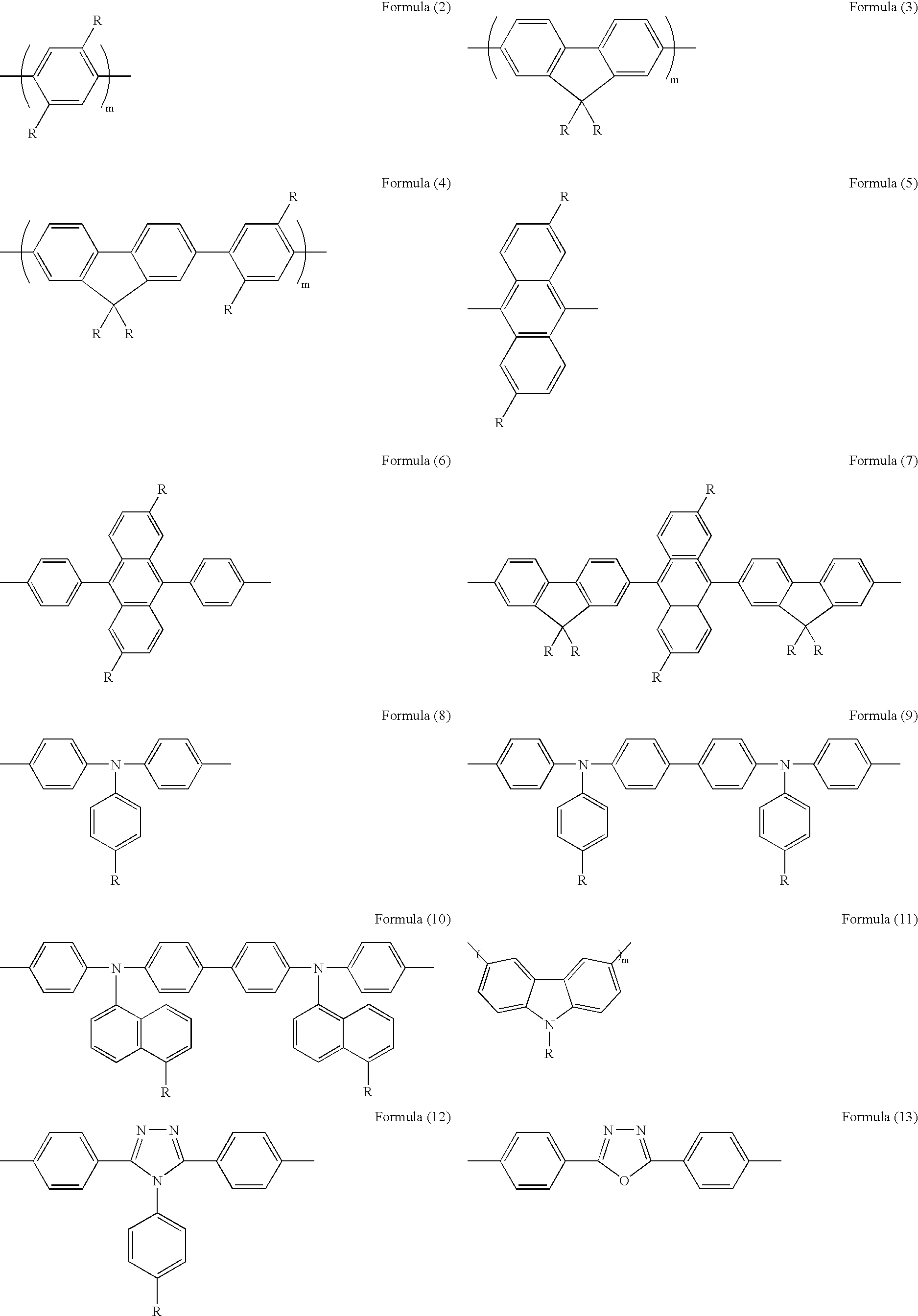

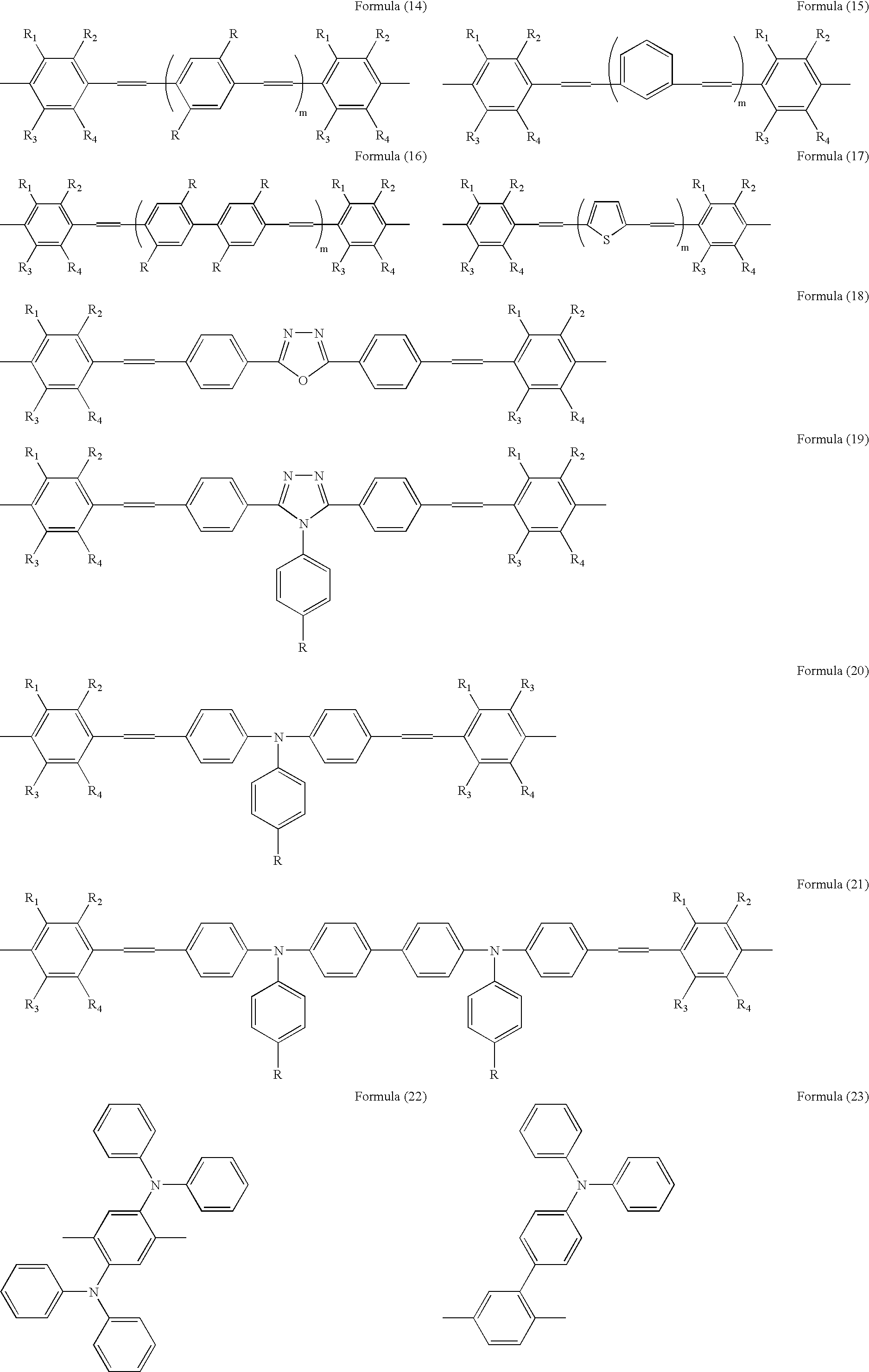

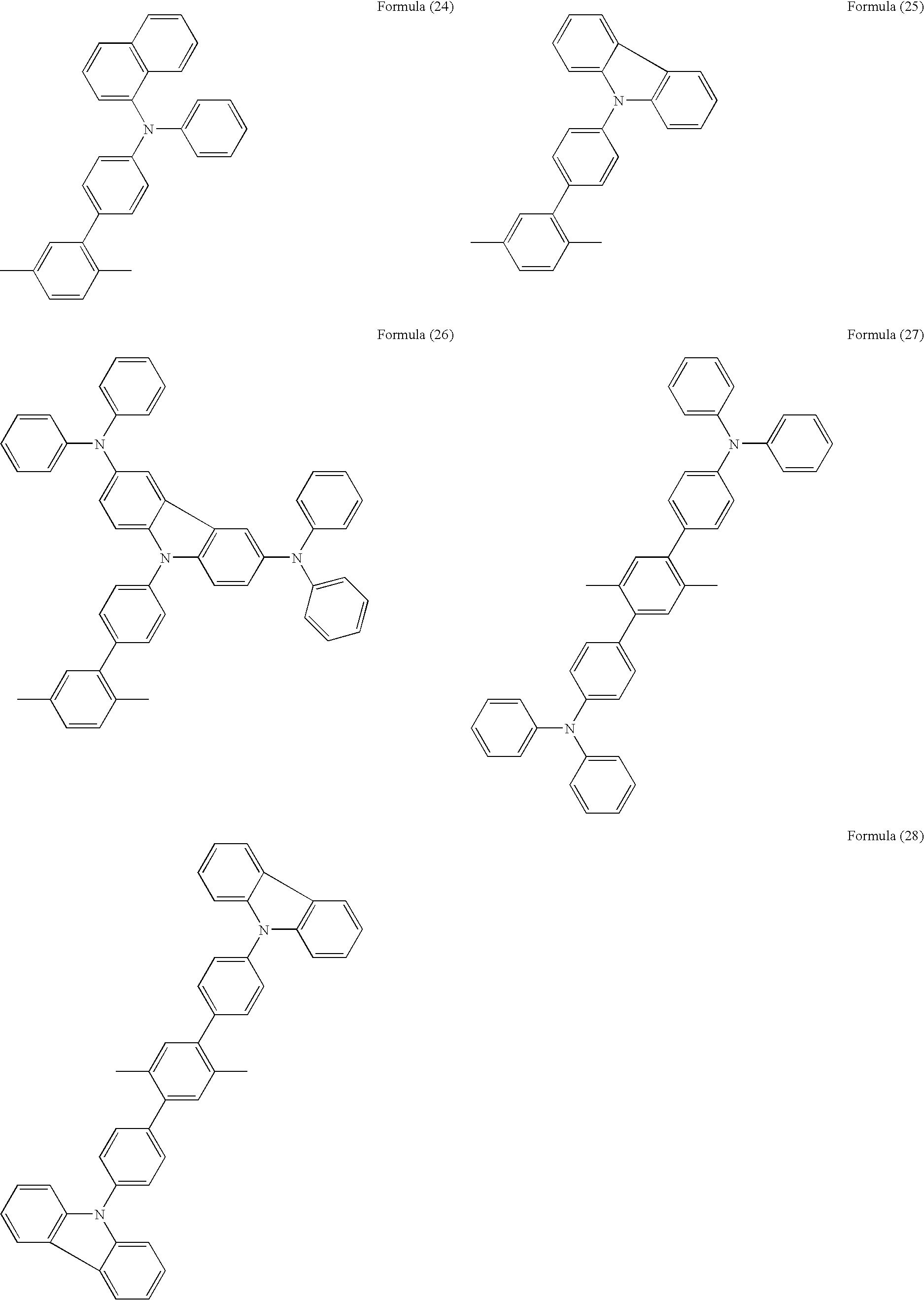

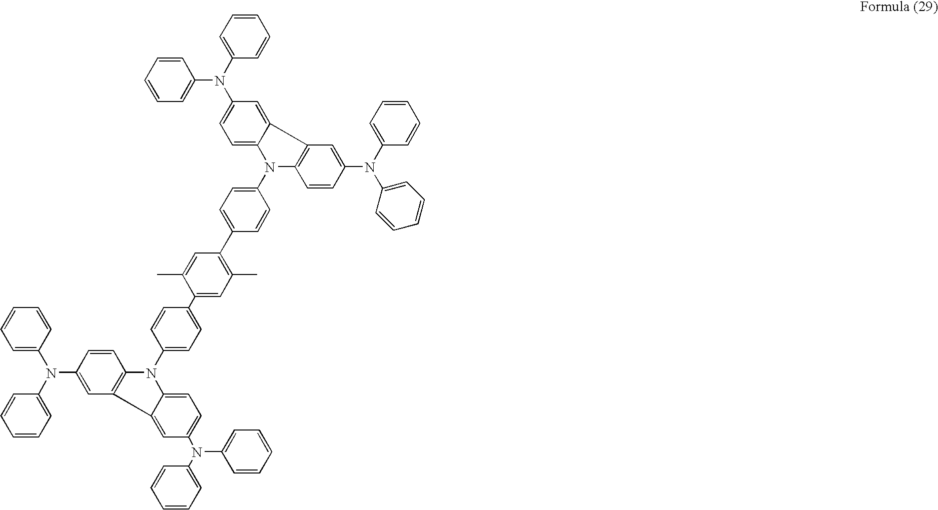

Ar₂ being one or two luminous structural elements selected from a group consisting of formula (30)-formula (44), wherein R each independently is hydrogen, alkyl, alkoxy, optionally substituted phenyl or naphthyl; m=1-10;

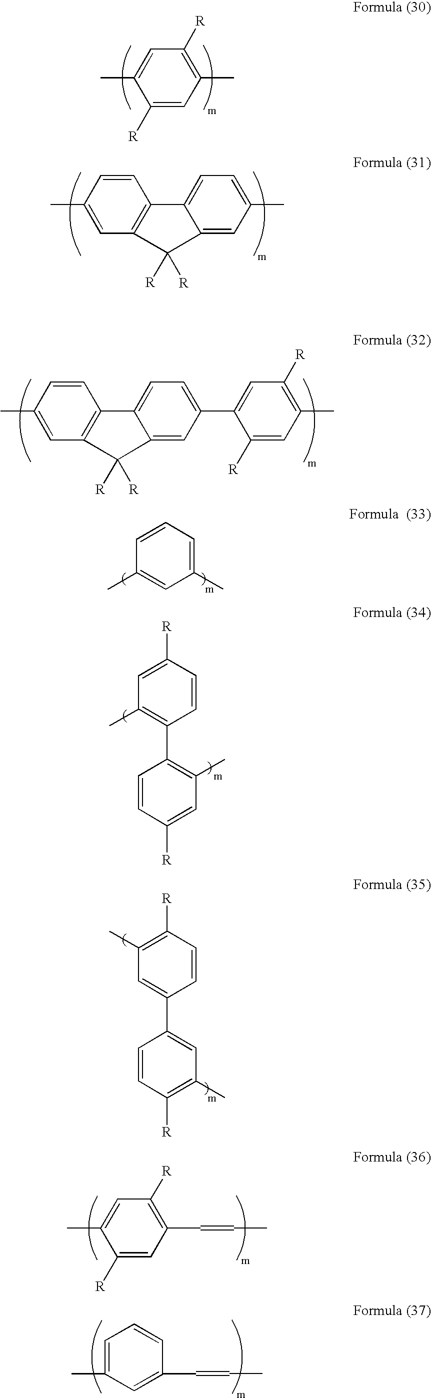

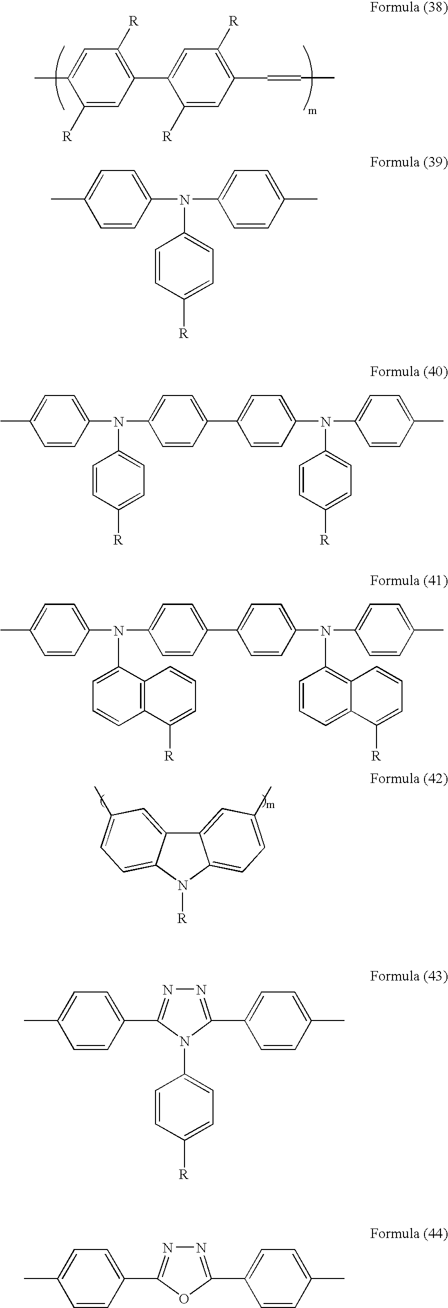

According to another aspect of the present invention, there is provided a process for preparing said energy-transfer type poly(p-phenylene vinyl) polymeric luminescent material, comprising the step of copolymerizing at least one Ar₁-containing aromatic dialdehyde monomer represented by general formula (45) and at least one Ar₂-containg aromatic diphosphinium monomer represented by general formula (46) at an equal molar amount,

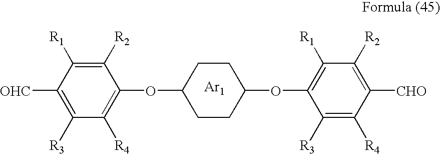

wherein R₁, R₂, R₃ and R₄ each independently is hydrogen, alkyl, alkoxy, optionally substituted phenyl or naphthyl; Ar₁ is the same as that in above mentioned polymeric structure;

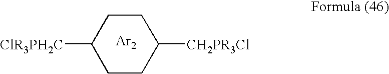

wherein Ar₂ is the same as that in above-mentioned polymeric structure; R is phenyl, ethyl, ethoxyl, propyl, butyl, pentyl, hexyl or octyl.

### DETAILED DESCRIPTION OF THE PREFERRED EMBODIMENTS

In the present invention, unless otherwise indicated, following terms have the following meanings:

Alkyl indicates linear or branched alkyl having 1-18 carbon atoms, optionally substituted with, for example, halogen, amino or nitro.

Alkoxy indicates the group —OR, wherein R is an alkyl defined as above.

Halogen indicates fluorine, chlorine, bromine or iodine.

Optionally substituted phenyl or naphthyl indicates optionally substituted phenyl or naphthyl with alkyl, alkoxy, halogenated alkyl, halogen, phenyl, naphthyl, arylamino or diarylamino, or carbozyl, wherein the arylamino or diarylamino includes but are not limited to N,N′-diphenylamino, N-phenyl-N′-1-naphthylamino and N,N′-di(1-naphthylamino.

Next, the technical solution of the present invention will be described in detail.

According to the present invention, there is provided an energy-transfer type poly(p-phenylene vinyl) polymeric luminescent material, which has the structural unit as represented by the following formula (1):

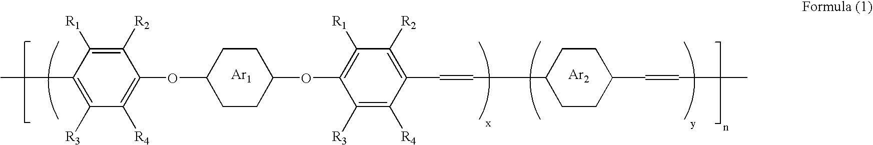

wherein R₁, R₂, R₃, and R₄ each independently is hydrogen, alkyl, alkoxy, optionally substituted phenyl or naphthyl; preferably, R₁, R₂, R₃, and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl;

x and y each is the content of the luminous element, satisfying 0<x 1, 0 y<1, x+y=1; and

n=1-200.

Ar₁ being one or two structural luminous elements selected from a group consisting of formula (2)-formula (29), wherein R, R₁, R₂, R₃ and R₄ each independently is hydrogen, alkyl, alkoxy, optionally substituted phenyl or naphthyl; preferably, R, R₁, R₂, R₃ and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl; and

m=1-10;

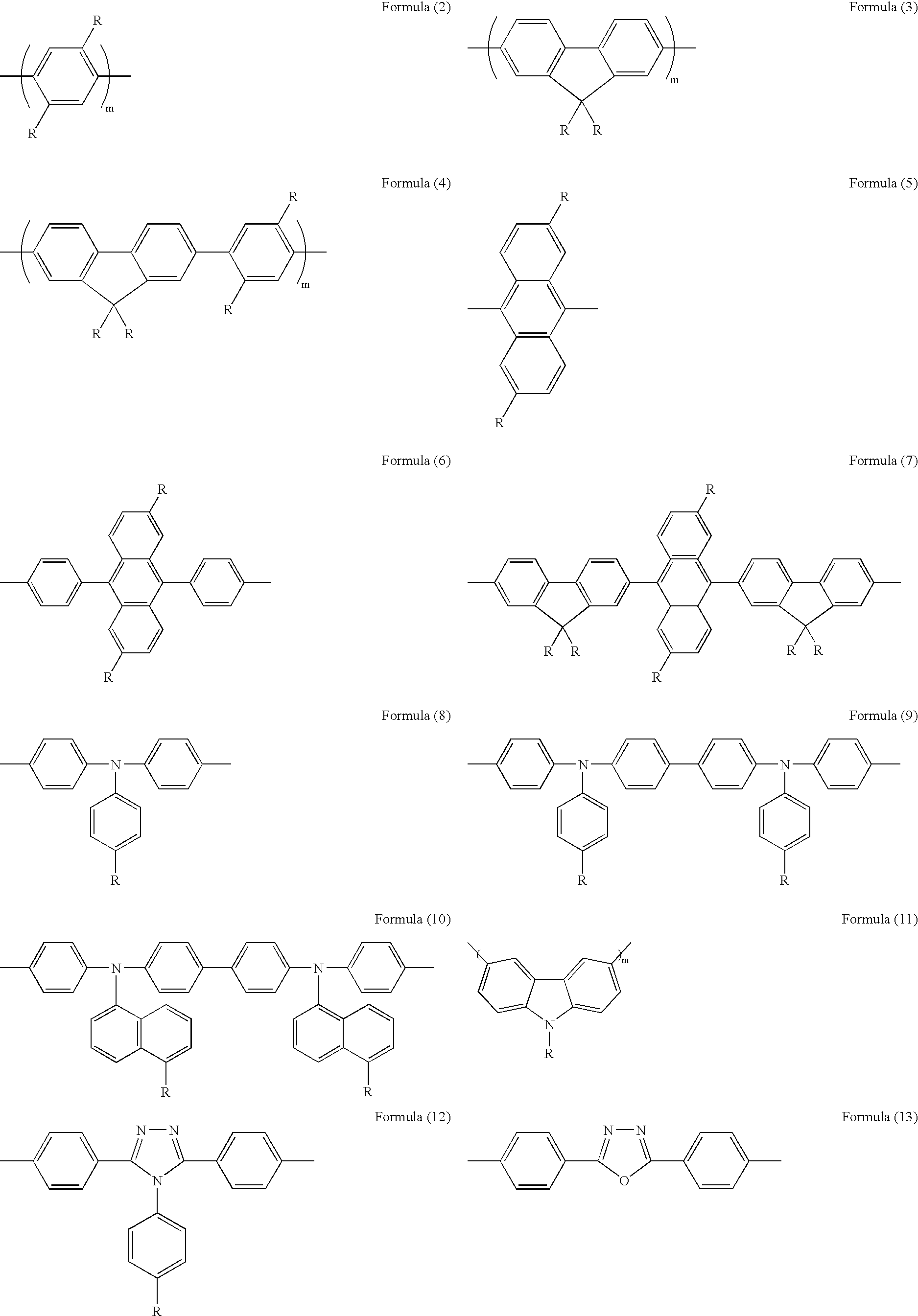

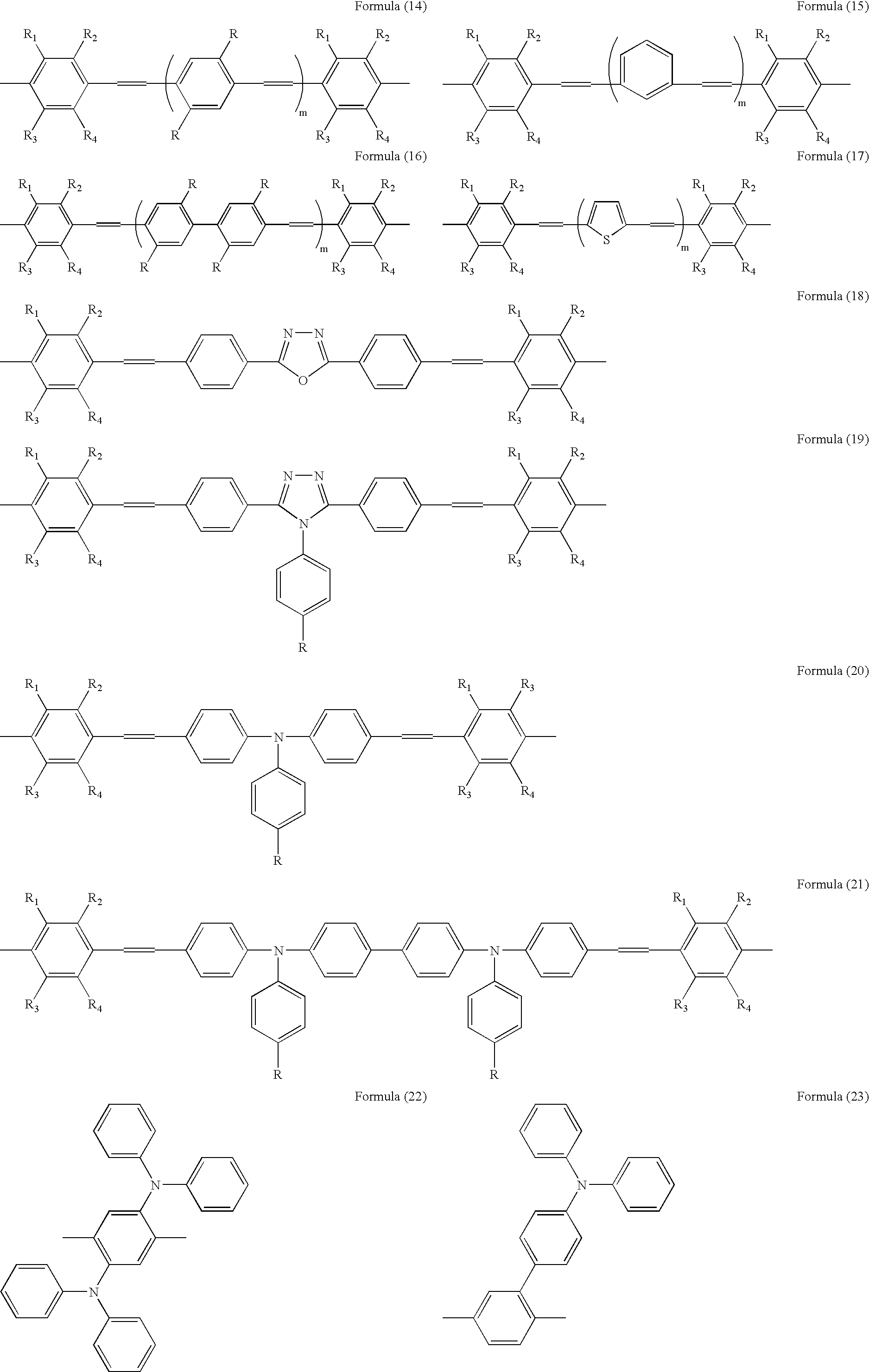

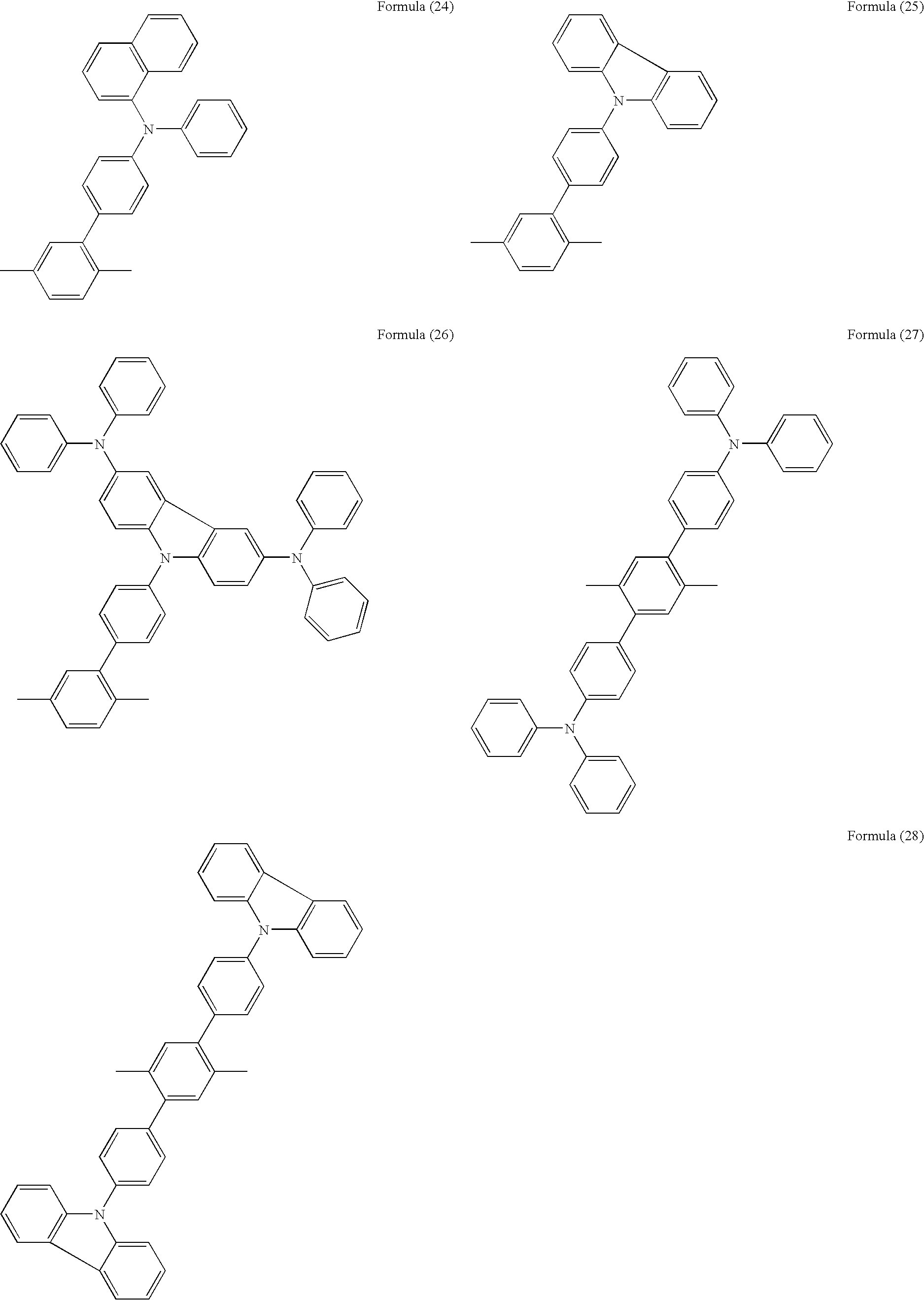

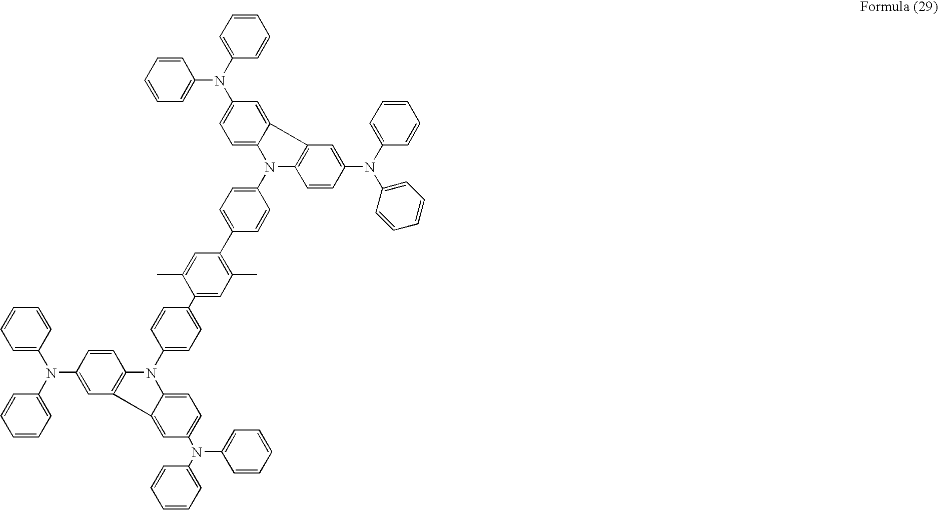

Ar₂ being one or two luminous structural elements selected from a group consisting of formula (30)-formula (44), wherein R each independently is hydrogen, alkyl, alkoxy, optionally substituted phenyl or naphthyl; preferably, R each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl; and m=1-10;

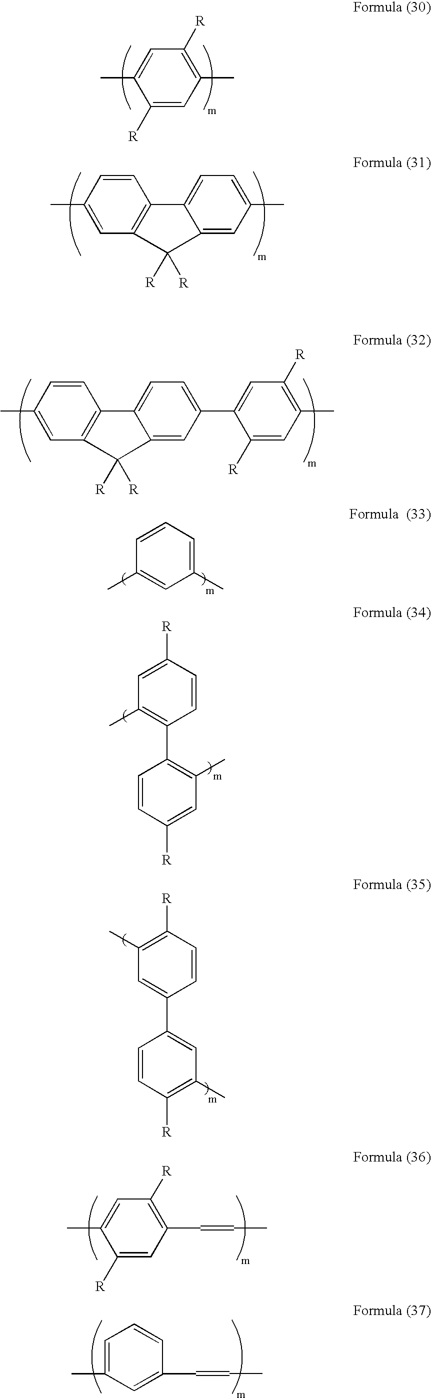

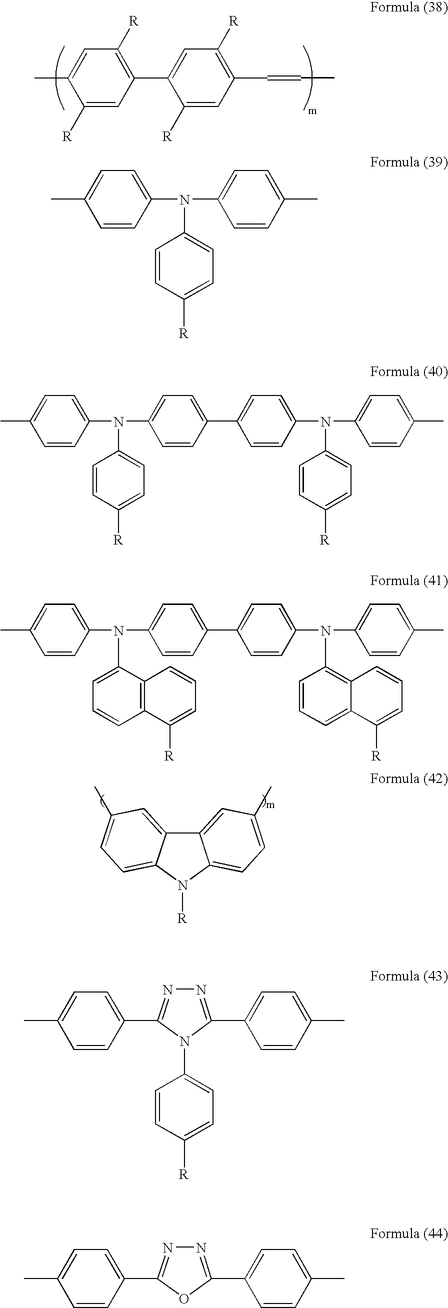

According to the present invention, there is provided a process for preparing said energy-transfer type poly(p-phenylene vinyl) polymeric luminescent material, comprising the step of copolymerizing at least one Ar₁-containing aromatic dialdehyde monomer represented by general formula (45) and at least one Ar₂-containg aromatic diphosphinium monomer represented by general formula (46) at an equal molar amount,

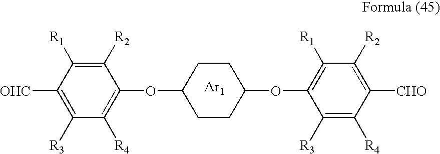

wherein R₁, R₂, R₃ and R₄ each independently is hydrogen, alkyl, alkoxy, optionally substituted phenyl or naphthyl; preferably R₁, R₂, R₃ and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl; Ar₁ is defined as in above formula (1);

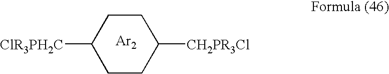

wherein Ar₂ is defined as in above formula (1); R is phenyl, ethyl, ethoxyl, propyl, butyl, pentyl, hexyl or octyl. The aromatic dialdehyde monomer containing an ether bond as represented by formula (45) can be prepared by the following method.

4,4′-dihydroxy substituted Ar₁ and p-fluorobenzaldehyde at a molar ratio of 1:2-3 are dissolved in N,N′-dimethylformamide to produce a solution. The solution is refluxed in the presence of anhydrous K₂CO₃ at a molar ratio of 1:2 for 2-24 hrs. The solution is cooled. Then the product is precipitated with anhydrous ethanol, filtered and washed with water, dried, and finally separated by column chromatography to obtain an aromatic Ar₁ dialdehyde monomer containing an ether bond (purity above 99%).

The aromatic diphosphinium monomer represented by formula (46) can be prepared by the following method.

An aromatic Ar₂ di(benzylchloride) and triphenylphosphine or tributylphosphine at a molar ratio of 1: 2-3 are dissolved in N,N′-dimethylformamide to form a mixture. The mixture is reacted for 1-24 hrs at 120° C. under N₂ atmosphere. Then the reaction mixture is cooled to room temperature. The product is precipitated with a great quantity of diethyl ether, then washed with diethyl ether for several times, filtered and dried to obtain an aromatic Ar₂ diphosphinium monomer.

In a specific embodiment according to the present invention, the poly(p-phenylene vinyl) polymeric luminescent material in which two different luminous elements coexist can be prepared by the following method:

a poly(p-phenylene viny) polymeric luminescent material, in which different luminous elements are fully isolated by an ether bond, is prepared through Wittig reaction, comprising:

The aromatic Ar₁ dialdehyde monomer and the aromatic Ar₂ diphosphinium monomer at an equal molar amount are dissolved in anhydrous trichloromethane. Then a solution of sodium ethanolate in ethanol at a molar ratio of 1:2-6 is added. The resultant mixture is reacted for 1-12 hrs with magnetic stirring under N₂ atmosphere. The reaction is stopped by the addition of 0.1N hydrochloric acid. The resultant mixture is extraction-separated with dichloromethane. The organic phase is collected and washed 3 times with 0.1N dilute hydrochloric acid, 3 times with 0.1N ammonia solution, and finally washed several times with water. The washed organic phase is dried with anhydrous Na₂SO₄, and concentrated in a rotary evaporator. The product is settled in methanol to obtain the crude product of a polymeric luminescent material. The crude product is extracted with acetone, dissolved and settled 3 times respectively with chloroform and methanol, and vacuum dried to obtain a purified polymeric luminescent material.

In another specific embodiment according to the present invention, a poly(p-phenylene vinylene) polymeric luminescent material, in which more than two kinds of different luminous elements co-exist, can be prepared as follows:

The process for preparing a poly(p-phenylene vinylene) polymeric luminescent material in which two or more luminous elements coexist is substantially the same as above, except that there are two or more aromatic Ar₁ dialdehyde monomers and two or more aromatic Ar₂ diphosphinium monomers, satisfying that the total moles of aromatic Ar₁ dialdehyde monomers is equal to that of aromatic Ar₂ diphosphinium monomers.

Though not bound to any theory, it is believed that, according to the present invention, a conjugated polymeric oligomer capable of emitting long wave and a conjugated polymeric oligomer capable of emitting short wave are alternatively and randomly copolymerized to the backbone of a polymer through Wittig reaction to form an energy transfer type poly(p-phenylene vinyl) polymeric luminous material having two or more kinds of luminous elements in the backbone. The conjugated length of each kind of luminous element can be adjusted and different luminous elements can be effectively isolated by an ether bond as a linking element and a isolating element. Meanwhile, different luminous elements can independently radiate, which provides the precondition of energy transfer between different luminous elements in relation to molecular structure and therefore the fluorescence quantum efficiency can be improved.

The following examples are just to explain the present invention and in no way limit the present invention.

### EXAMPLE 1

### Synthesis of 1,4-dichloromethyl phenyl di(tributyl phosphinium)

17.5 g (100 mmol) of 1,4-dibenzylchloride and 60.6 g (300 mol) of tributylphosphine were dissolved in 30 ml of N,N-dimethylformamide to form a solution. The solution was refluxed at 120° C. for 12 hrs under N₂ atmosphere. Then the solution was cooled, poured into a great quantity of diethyl ether. The solution was washed repeatedly with diethyl ether, filtered and dried to obtain a white solid, yield˜90%.

¹H-NMR (CDCl₃, 400 MHz, ppm): 7.62 (s, 4H), 4.42 (d, J=14.8 Hz, 4H), 2.38 (t, 12H), 1.49 (m, 24H), 0.93 (t, 18H).

FT-IR (KBr): 2960, 2932, 2873, 2797, 1514, 1464, 1100, 860 cm⁻¹.

### EXAMPLE 2

### Synthesis of 1,3-dichloromethylphenyl di(tributyl phosphinium)

The procedures were the same as those in example 1, except that 17.5 g (100 mmol) of 1,3-dibenzylchloride was used in place of 1,4-dibenzylchloride. The yield˜90%.

¹H-NMR (CDCl₃, 400 MHz, ppm): 8.21 (s, 1H), 7.56 (d, 2H), 7.40 (t, 1H), 4.33 (d, J=15.6 Hz, 4H), 2.40 (m, 12H), 1.49 (m, 24H), 0.95 (t, 18H).

### EXAMPLE 3

### Synthesis of 2,5-dichloromethylthienyl di(tributyl phosphinium)

18.0 g (100 mmol) of 2,5-dichloromethylthiophene and 60.6 g (300 mol) of tributylphosphine were dissolved in 30 ml of N,N-dimethylformamide to form a solution. The solution was refluxed at 120° C. for 12 hrs under N₂ atmosphere. The solution was cooled, poured into a great quantity of diethyl ether. The solution was washed repeatedly with diethyl ether, filtered and dried to obtain a light yellow solid, yield˜85%.

¹H-NMR (CDCl₃, 400 MHz, ppm): 7.23 (s, 2H), 4.68 (d, J=12.8 Hz, 4H), 2.43 (m, 12H), 1.49 (m, 24H), 0.95 (t, 18H).

### EXAMPLE 4

### Synthesis of 4,4′-dichloromethylbiphenyl di(tributyl phosphinium)

The procedures were the same as those in example 1, except that 25.1 g (100 mol) of 4,4′-dichloromethylbiphenyl was used in place of 1,4-dibenzylchloride to obtain a white solid. The yield˜90%.

### EXAMPLE 5

### Synthesis of 2,5-di(4-tributylphosphinochloromethylphenyl)-1,3,4-oxadiazole

The procedures were the same as those in example 1, except that 31.9 g (100 mmol) of 2,5-di(4-chloromethylphenyl)-1,3,4-oxadiazole was used in place of 1,4-dibenzylchloride to obtain a light yellow solid. The yield˜80%.

¹H-NMR (CDCl₃, δppm); 8.0 (d, 4H), 7.6 (d, 4H), 4.8 (d, 4H), 2.4 (m, 12H), 1.5 (m, 24H), 0.9 (t, 18H).

### EXAMPLE 6

### Synthesis of 4-phenyl-3,5-di(4-tributylphosphinochloromethylphenyl)-1,2,4-triazole

The procedures were the same as those in example 1, except that 39 g (100 mmol) of 4-phenyl-3,5-di(4-tributylphosphinochloromethylphenyl)-1,2,4-triazole was used in place of 1,4-dibenzylchloride to obtain a light green solid. The yield˜73%.

¹H-NMR (CDCl₃, δppm); 7.5-7.8 (m, 13H), (d, 4H), 4.8 (d, 4H), 2.4 (m, 12H), 1.5 (m, 24H), 0.9 (t, 18H).

### EXAMPLE 7

### Synthesis of 2-methoxyl-5-(2′-ethylhexyoxyl)-1,4-di(2′-((3′,5′-dimethoxyl)-4′-hydroxylphenyl)vinyl)benzene

4.8 g of NaH (60%, 200 mmol) was dissolved in 50 ml of an anhydrous DMF under nitrogen atmosphere to form a mixture. Then 50 ml of a solution of 13.0 g (20 mmol) of 2-methoxyl-5-(2′-ethylhexyoxyl)-1,4-di(butyloxylphosphate) xylene in DMF was slowly added drop-wise into the mixture with magnetic stirring. The resultant mixture was reacted at room temperature for six hours. Then a solution of 7.5 g (41 mmol) of 3,5-dimethoxylp-hydroxylbenzaldehyde in DMF was slowly added dropwise into the mixture. The resultant mixture was reacted at room temperature under nitrogen atmosphere for about another 12 hours. Finally the reaction was stopped by adding 100 ml of 1N dilute hydrochloric acid. The yellow precipitate formed was filtered, extracted, dried and separated by column chromatogram (The eluate is ethyl acetate:petroleum ether=1:1 (V/V)) to obtain a bright yellow solid 9.7 g. The yield was 83%.

¹H-NMR (CDCl₃, 6 ppm); 7.0-7.4 (m, 10H), 5.6 (s, 2H), 3.9 (m, 17H), 0.9-1.8 (m, 17H).

### EXAMPLE 8

### Synthesis of 2-methoxyl-5-(2′-ethylhexyloxyl)-1,4-di(2′-(4′-hydroxylphenyl)vinyl)benzene

The procedures were the same as those in example 7, except that 5.0 g (41 mmol) of p-hydroxylbenzaldehyde was used in place of 3,5-dimethoxyl p-hydroxylbenzaldehyde, to obtain a yellow solid. The yield was 80%.

¹H-NMR (CDCl₃, 8 ppm); 7.0-7.4 (m, 10H), 5.6 (s, 2H), 3.9 (m, 5H), 0.9-1.8 (m, 17H).

### EXAMPLE 9

### Synthesis of 1,4-di(2′-((3′,5′-dimethoxyl)-4′-hydroxylphenyl)vinyl)benzene

40 ml of a solution of 9.8 g (20 mmol) of 1,4-di(butyloxylphosphate) xylene in DMF was added drop-wise into a 50 ml DMF solution containing 4.8 g (200 mol) NaH (60%) under nitrogen atmosphere. The resultant mixture was reacted at room temperature for 24 hrs with magnetic stirring. Then 50 ml of a solution of 7.5 g (41 mmol) of 3,5-dimethoxyl-p-hydroxylbenzaldehyde in DMF was added. The reaction continued for another 12 hrs. The reaction was stopped by adding dilute hydrochloric acid. The reaction product was filtered, dried and separated by column chromatogram to obtain a bright yellow solid emitting strong fluorescence 8.5 g. The yield was 82%.

¹H-NMR (CDCl₃, δppm): 6.8-7.4 (m, 10H), 4.7 (s, 2H), 4.0 (m, 12H).

### EXAMPLE 10

### Synthesis of 2,5-dihexyloxyl-1,4-di(2′-((3′,5′-dimethyloxyl)-4′-hydroxylphenyl)vinyl)benzene

The procedures were the same as those in example 7, except that 13.8 g (20 mmol) of 2,5-dihexyloxyl-1,4-di(butyloxylphosphate) xylene was used in place of 2-methoxyl-5-(2′-ethylhexyloxyl)-1,4-di(butyloxylphosphate) xylene, to obtain a light yellow solid 11.8 g. The yield was 80%.

¹H-NMR (CDCl₃, δppm): 6.8-7.4 (m, 12H), 5.5 (s, 2H), 3.9-4.1 (m, 16H), 0.9-1.8(m, 22).

### EXAMPLE 11

### Synthesis of 1,4-di(2′-(3′,5′-dimethoxyl-4′-(4′-formaldehydephenyloxyl)phenyl)vinyl)benzene

4.3 g (10 mmol) of 1,4-di(2′-(3′,5′-dimethoxyl-4′-hydroxylphenyl)vinyl) benzene, 5.0 g (40 mmol) of p-fluorobenzaldehyde and 2.7 g (20 mmol) of anhydrous potassium carbonate were dissolved in 50 ml of N,N-dimethylformamide to produce a mixture. The mixture was refluxed 24 hrs under nitrogen atmosphere. The reaction product was precipitated with methanol, filtered and washed with distilled water, and then dried and separated by column chromatogram (eluate is dichloromethane) to obtain a yellow solid 5.0 g. The yield was 80%.

¹H-NMR (CDCl₃, δppm); 10.2 (s, 2H), 7.0-7.4 (m, 20H), 3.9 (t, 12H).

### EXAMPLE 12

### Synthesis of 3-methoxyl-5-(2-ethylhexyloxyl)-1,4-di(2′-(3′,5′-dimethoxyl-4′-(4′-formaldehydephenyloxyl)phenyl)vinyl)benzene

6.0 g (10 mmol) of 3-methoxyl-5-(2-ethylhexyloxyl)-1,4-di(2′-(3′,5′-dimethoxyl-4′-hydroxylphenyl)vinyl)benzene, 5.0 g (40 mmol) of p-fluorobenzaldehyde and 2.7 g (20 mmol) of anhydrous potassium carbonate were dissolved in 50 ml of N,N-dimethylformamide to produce a mixture. The mixture was refluxed 24 hrs under nitrogen atmosphere. The reaction product was precipitated with methanol, filtered and washed with distilled water, and then dried and separated by column chromatogram to obtain a yellow solid 6.4 g. The yield was 82%.

¹H-NMR (CDCl₃, δppm); 10.2 (s, 2H), 7.0-7.4 (m, 18H), 3.9 (m, 17H), 0.9-1.8 (m, 17H).

### EXAMPLE 13

### Synthesis and Characterization of a Polymeric Luminous Material P1

0.29 g (0.5 mmol) of 1,4-dichloromethylphenyl tributylphosphine salt and 0.40 g (0.5 mmol) of 2-methoxyl-5-(2-ethylhexyloxyl)-1,4-di(2′-(3′,5′-dimethoxyl-4′-(4′-formaldehydephenyloxyl)phenyl)vinyl)benzene were dissolved in 10 ml of anhydrous trichloromethane to form a mixture. Then 3 ml of a 0.3N solution of sodium ethanolate in ethanol was added drop-wise. The resultant mixture was reacted for 5 hrs under nitrogen atmosphere. The reaction was stopped by the addition of dilute hydrochloric acid. The reaction product was extracted with dichloromethane, washed 3 times with 0.1N dilute hydrochloric acid, washed 3 times with 0.1N ammonia, and washed with water for several times. The product was dried, concentrated, precipitated with methanol, thermally-extracted with acetone and vacuum dried to obtain a yellow fibrous product P1. The yield was 70%.

¹H-NMR (CDCl₃, 300 MHz, ppm): 7.53˜6.86, 3.97˜3.84, 1.56˜0.88. Elemental calcd for (C₃₅H₄₂O₇)(C₂₂H₁₆O): C, 78.62; H, 6.67. Found: C, 78.12; H, 6.73.

The final product had a weight average molecular weight of 3.8×10⁴, a number average molecular weight of 2.0×10⁴, and a maximal luminous peak at 500 nm in the fluorescence spectrum in the form of a thin film.

A single-layer element having a structure ITO/PEDOT/P1/Ca/Al was assembled as follows. A pre-cleaned ITO glass was used as an anode. A layer of conductive polymer, a derivative of polythiophene (PEDOT) was spin coated on the surface of the anode and the thickness of the layer was 100 nm. The PEDOT-coated ITO was vacuum dried for one hour at 100° C. Then a 10 mg/ml solution of P1 in chloroform was spin coated on the surface of the ITO at 1500 rpm. Next, calcium metal and aluminum metal were deposited at a high vacuum, respectively having a thickness of 10 nm and 100 nm. The obtained single-layer element had the performances of a turn-on voltage of 8.8V, the maximal luminance of 190 cd/m², a maximal luminous efficiency of 0.042 cd/A and a maximal electroluminescence peak at 505 nm.

### EXAMPLE 14

### Synthesis and Characterization of a Polymeric Luminous Material P2

The procedures were the same as those in example 13, except that 1.36 g (1.88 mmol) of 2,5-di(4-tributylphosphinochloromethylphenyl)-1,3,4-oxadiazole and 1.50 g (1.88 mmol) of 3-methoxyl-5-(2-ethylhexyloxyl)-1,4-di(2′-(3′,5′-dimethoxyl-4′-(4′-formaldehydephenyloxyl)phenyl)vinyl)benzene were dissolved in 50 ml of chloroform to form a mixture. A yellow fibrous solid P2 was obtained and the yield was 60%.

¹H-NMR (CDCl₃, 300 MHz, ppm): 8.10, 7.53˜6.86, 3.97˜3.84, 1.56˜0.88.

Elemental calcd for (C₃₅H₄₂O₇)(C₂₂H₁₆O)_{0.8}(C₃₀H₂OO₂N₂)_{0.2}: C, 78.22; H, 6.54; N, 0.62 Found: C, 78.30; H, 6.42; N, 0.55.

The final product had a weight average molecular weight of 4.0×10⁴, a number average molecular weight of 2.0×10⁴, and a maximal luminous peak at 500 nm in the fluorescence spectrum in the form of a thin film.

A single-layer element was assembled as in example 13. The obtained single-layer element had the performances of a turn-on voltage of 7.0V, a maximal luminance of 450 cd/m², a maximal luminous efficiency of 0.07 cd/A and a maximal electroluminescence peak at 501 nm.

### EXAMPLE 15

### Synthesis and Characterization of a Polymeric Luminous Material P3

The procedures were the same as those in example 13, except that 0.68 g (0.935 mmol) of 2,5-di(4-tributylphosphinochloromethylphenyl)-1,3,4-oxadiazole, 1.50 g (1.87 mmol) of 3-methoxyl-5-(2-ethylhexyloxyl)-1,4-di(2′-(3′,5′-dimethoxyl-4′-(4′-formaldehydephenyloxyl)phenyl)vinyl) benzene and 0.5 g (0.935 mmol) of 1,4-dichloromethylphenyltributylphosphino salt were dissolved in 50 ml of chloroform to form a mixture. A yellow fibrous solid P3 was obtained and the yield was 70%.

¹H-NMR (CDCl₃, 300 MHz, ppm): 8.10, 7.63˜6.86, 3.97˜3.84, 1.56˜0.88(m, 15H).

Elemental calcd for (C₃₅H₄₂O₇)(C₂₂H₁₆O)_{0.5}(C₃₀H₂OO₂N₂)_{0.5}: C, 77.71; H, 6.37; N, 1.49. Found: C, 78.30; H, 6.42; N, 1.57.

The final product had a weight average molecular weight of 3.5×10⁴, a number average molecular weight of 2.9×10⁴, and a maximal luminous peak at 500 nm in the fluorescence spectrum in the form of a thin film.

A single-layer element was assembled as in example 13. The obtained single-layer element had the performances of a turn-on voltage of 7.3V, the maximal luminance of 625 cd/m², maximal luminous efficiency of 0.18 cd/A and maximal electroluminescence peak at 501 nm.

### EXAMPLE 16

### Synthesis and Characterization of a Polymeric Luminous Material P4

The procedures were the same as those in example 13, except that 0.72 g (1 mmol) of 2,5-di(4-tributylphosphinochloromethylphenyl)-1,3,4-oxadiazole and 0.80 g (1 mmol) of 3-methoxyl-5-(2-ethylhexyloxyl)-1,4-di(2′-(3′,5′-dimethoxyl-4′-(4′-formaldehydephenyloxyl)phenyl)vinyl) benzene were dissolved in 50 ml of chloroform to form a mixture and 1.5 ml of a 0.5N solution of sodium ethanolate in ethanol was added drop-wise. A light yellow fibrous solid P4 was obtained and the yield was about 73%.

¹H-NMR (CDCl₃, 300 MHz, ppm): 8.14, 7.63˜6.86, 3.97˜3.84, 1.56˜0.88.

Elemental calcd for (C₃₅H₄₂O₇) (C₃₀H₂₀O₂N₂): C, 76.92; H, 6.11; N, 2.76. Found: C, 77.10; H, 6.0; N, 2.82.

The final product had a weight average molecular weight of 3.1×10⁴, a number average molecular weight of 2.3×10⁴, and a maximal luminous peak at 500 nm in the fluorescence spectrum in the form of a thin film.

A single-layer element was assembled as in example 13. The obtained single-layer element had the performances of a turn-on voltage of 7V, the maximal luminance of 1250 cd/m², and a maximal luminous efficiency of 0.30 cd/A.

### EXAMPLE 17

### Synthesis and Characterization of a Polymeric Luminous Material P5

The procedures were the same as those in example 13, except that 0.20 g (0.25 mmol) of 4-phenyl-3,5-di(4-tributylphosphinochloromethylphenyl)-1,2,4-triazole, 0.58 g (1.0 mmol) of 1,4-dichloromethylphenyltributylphosphino salt and 11.0 g (1.25 mmol) of 3-methoxyl-5-(2-ethylhexyloxyl)-1,4-di(2′-(3′,5′-dimethoxyl-4′-(4′-formaldehydephenyloxyl)phenyl)vinyl)benzene were dissolved in 50 ml of chloroform to form a mixture. A yellow fibrous solid P5 was obtained and the yield was 74%.

¹H-NMR (CDCl₃, 300 MHz, ppm): 7.53˜6.86, 3.97˜3.84, 1.56˜0.88.

Elemental calcd for (C₃₅H₄₂O₇)(C₂₂H₁₆O)_{0.8}(C₃₆H₂₅O₂N₃)_{0.2}: C, 78.53; H, 6.54; N, 0.92. Found: C, 78.68; H, 6.42; N, 1.03.

The final product had a weight average molecular weight of 2.6×10⁴, a number average molecular weight of 1.5×10⁴, and a maximal luminous peak at 500 nm in the fluorescence spectrum in the form of a thin film.

A single-layer element was assembled as in example 13. The obtained single-layer element had the performances of a turn-on voltage of 7.8V, maximal luminance of 131 cd/m², a maximal luminous efficiency of 0.089 cd/A and a maximal electroluminescence peak at 502 nm.

### EXAMPLE 18

### Synthesis and Characterization of a Polymeric Luminous Material P6

The procedures were the same as those in example 13, except that 0.50 g (0.63 mmol) of 4-phenyl-3,5-di(4-tributylphosphinochloromethylphenyl)-1,2,4-triazole, 0.36 g (0.63 mmol) of 1,4-dichloromethylphenyltributylphosphine salt and 1.0 g (1.25 mmol) of 3-methoxyl-5-(2-ethylhexyloxyl)-1,4-di(2′-(3′,5′-dimethoxyl-4′-(4′-formaldehydephenyloxyl)phenyl)vinyl)benzene were dissolved in 50 ml of chloroform to form a mixture. A yellow fibrous solid P6 was obtained and the yield was 82%.

¹H-NMR (CDCl₃, 300 MHz, ppm): 7.53˜6.86, 3.97˜3.84, 1.56˜0.88.

Elemental calcd for (C₃₅H₄₂O₇)(C₂₂H₁₆O)_{0.5}(C₃₆H₂₅O₂N₃)_{0.5}: C, 78.41; H, 6.38; N, 2.14. Found: C, 79.32; H, 6.08; N, 2.27.

The final product had a weight average molecular weight of 2.2×10⁴, a number average molecular weight of 1.3×10⁴, and a maximal luminous peak at 500 nm in the fluorescence spectrum in the form of a thin film.

A single-layer element was assembled as in example 13. The obtained single-layer element had the performances of a turn-on voltage of 7.3V, the maximal luminance of 338 cd/m², a maximal luminous efficiency of 0.20 cd/A and a maximal electroluminescence peak at 503 nm.

### EXAMPLE 19

### Synthesis and Characterization of a Polymeric Luminous Material P7

The procedures were the same as those in example 13, except that 0.50 g (0.63 mmol) of 4-phenyl-3,5-di(4-tributylphosphinochloromethylphenyl)-1,2,4-triazole and 0.50 g (0.63 mmol) of 3-methoxyl-5-(2-ethylhexyloxyl)-1,4-di(2′-(3′,5′-dimethoxyl-4′-(4′-formaldehydephenyloxyl)phenyl)vinyl)benzene were dissolved in 50 ml of chloroform to form a mixture. A yellow fibrous solid P7 was obtained and the yield was 77%.

¹H-NMR (CDCl₃, 300 MHz, ppm): 7.53˜6.86, 3.97˜3.84, 1.56˜0.88. Elemental calcd for (C₃₁H₄₂O₇) (C₃₆H₂₅O₂N₃): C, 78.24; H, 6.15; N, 3.86. Found: C, 80.02; H, 5.94; N, 3.83.

The final product had a weight average molecular weight of 2.5×10⁴, a number average molecular weight of 1.4×10⁴, and a maximal luminous peak at 500 nm in the fluorescence spectrum in the form of a thin film.

A single-layer element was assembled as in example 13. The obtained single-layer element had the performances of a turn-on voltage of 6.3V, the maximal luminance of 256 cd/m², a maximal luminous efficiency of 0.19 cd/A and a maximal electroluminescence peak at 501 nm.

### EXAMPLE 20

### Synthesis and Characterization of a Polymeric Luminous Material P8

The procedures were the same as those in example 13, except that 0.29 g (0.5 mmol) of 1,3-dichloromethylphenyltributyl phosphine was used in place of 1,4-dichloromethylphenyltributyl phosphine. A yellow fibrous solid P8 was obtained and the yield was 81%.

¹H-NMR (CDCl₃, 300 MHz, ppm): 7.50˜6.84 (m, 24H), 3.99˜3.82 (m, 17H), 1.56˜0.88(m, 15H).

Elemental calculated for (C₃₅H₄₂O₇)(C₂₂H₁₆O): C, 78.62; H, 6.67; Found: C, 78.32; H, 6.71.

The final product had a weight average molecular weight of 5.2×10⁴, a number average molecular weight of 2.3×10⁴, and a maximal luminous peak at 500 nm in the fluorescence spectrum in the form of a thin film.

A single-layer element was assembled as in example 13. The obtained single-layer element had the performances of a turn-on voltage of 8.8V, the maximal luminance of 800 cd/m², a maximal luminous efficiency of 0.53 cd/A and a maximal electroluminescence peak at 503 nm.

What we claim is:

1. An energy-transfer type light-emitting polymer based on poly(p-phenylene vinyl)s, which has the structural unit as represented by the following formula (1): 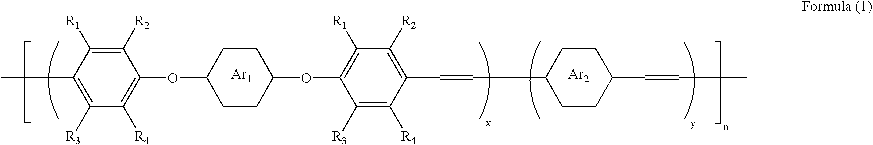
wherein R₁, R₂, R₃, and R₄ each independently is hydrogen, alkyl, alkoxy, optionally substituted phenyl or naphthyl; x and y each is the content of the luminous element, satisfying 0<x 1, 0 y<1, x+y=1; there can be one luminous element or more luminous elements having a content of x and so does the luminous element having a content of y; and n=1-200;
Ar₁ being one or two luminous structural elements selected from a group consisting of formula (2)-formula (29), wherein R, R₁, R₂, R₃ and R₄ each independently is hydrogen, alkyl, alkoxy, optionally substituted phenyl or naphthyl; m=1-10; 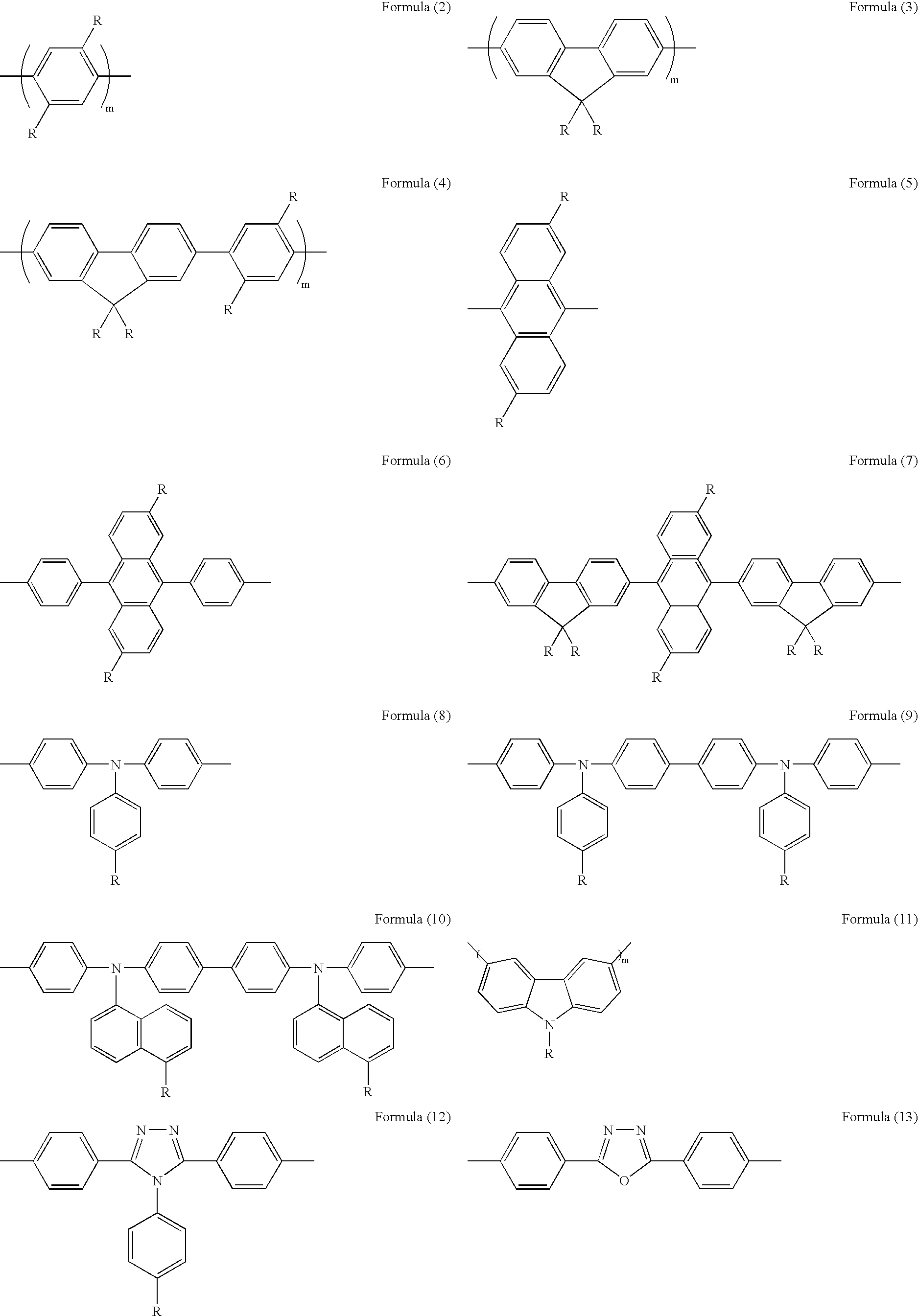 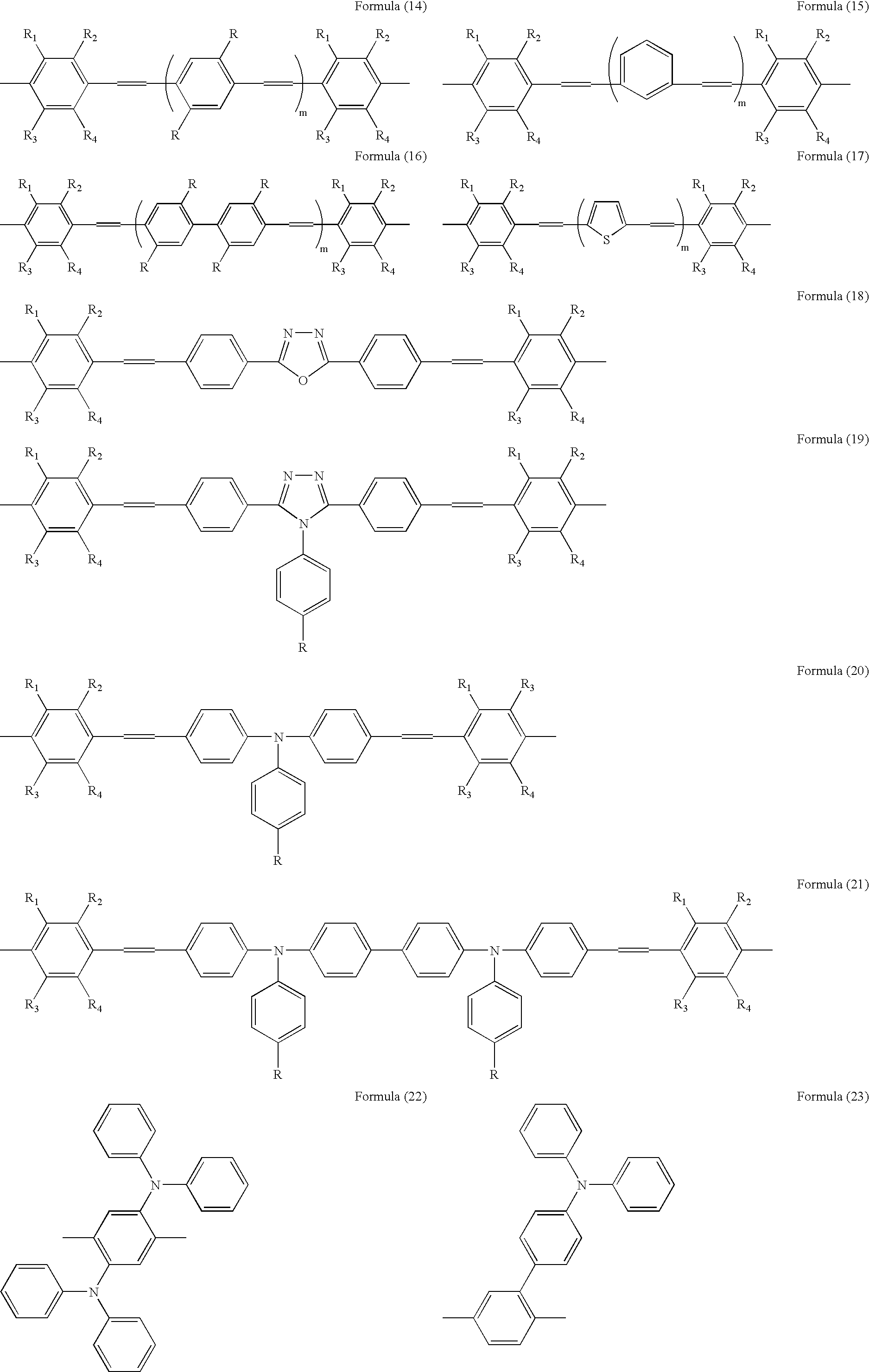 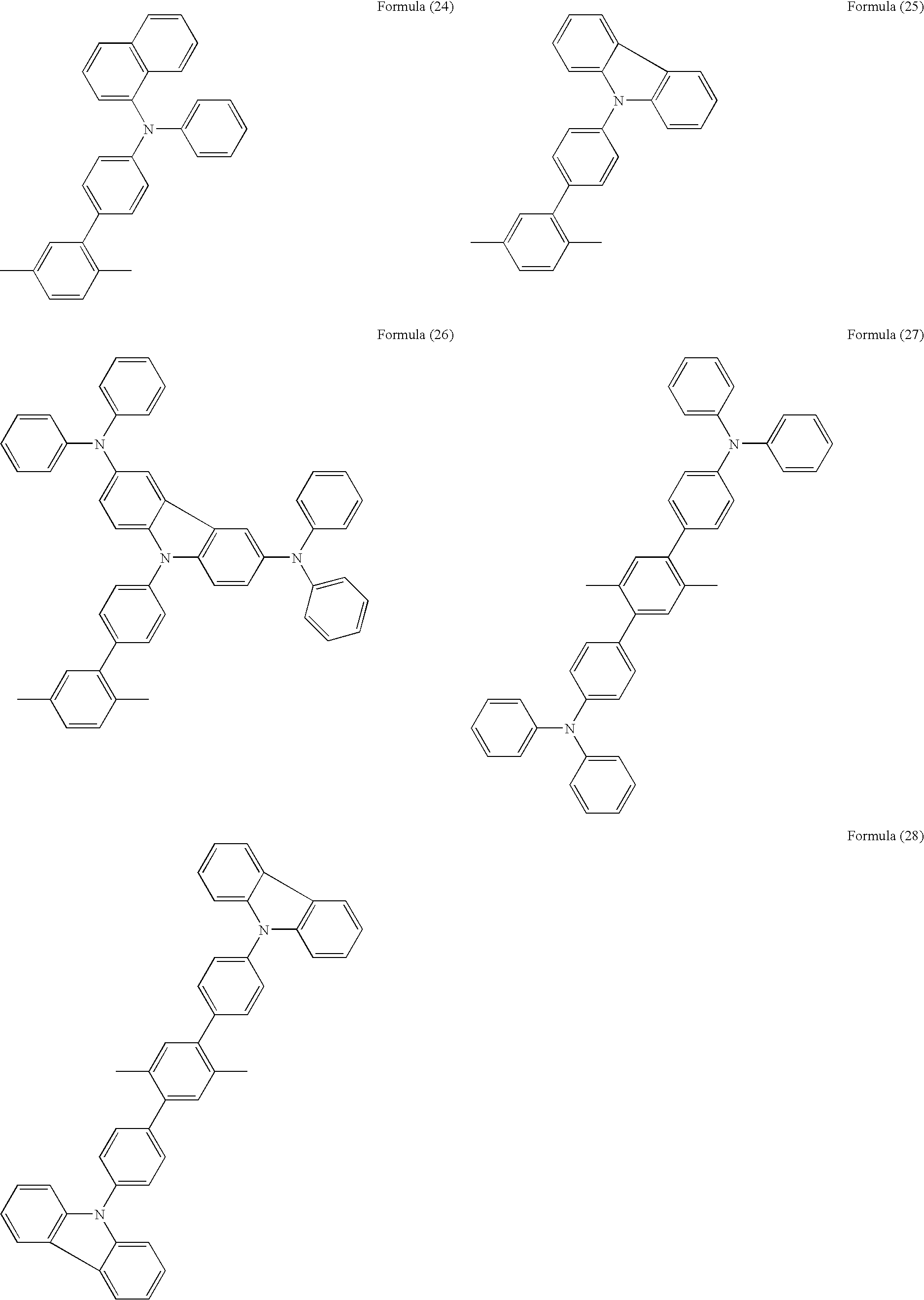 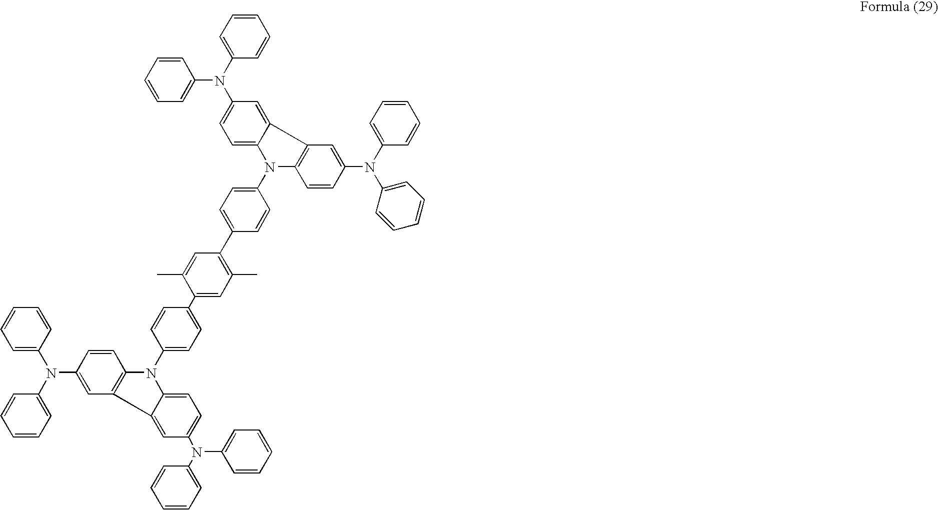
Ar₂ being one or two luminous structural elements selected from a group consisting of formula (30)-formula (44), wherein R each independently is hydrogen, alkyl, alkoxy, optionally substituted phenyl or naphthyl;
m=1-10;

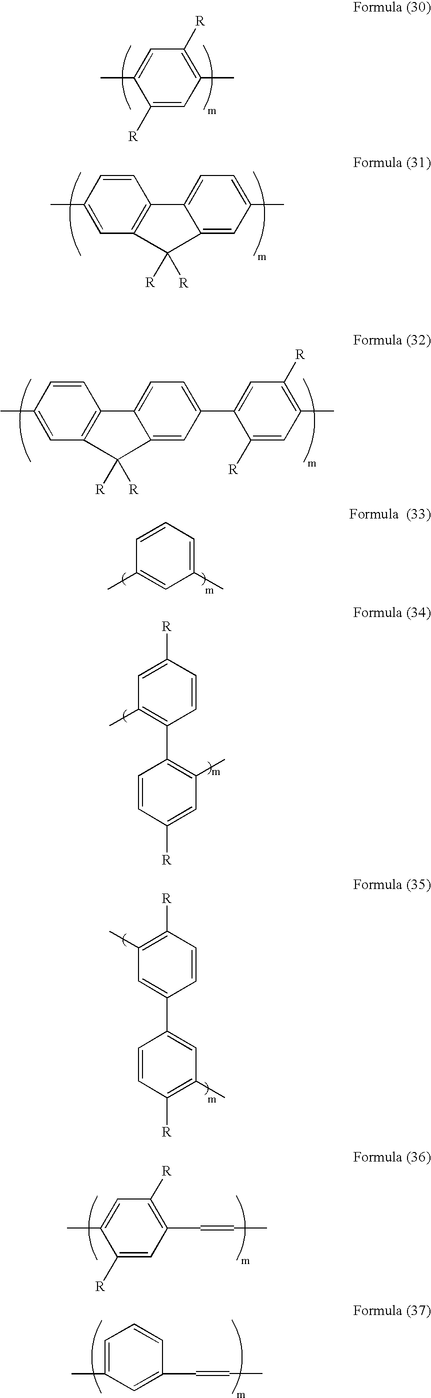

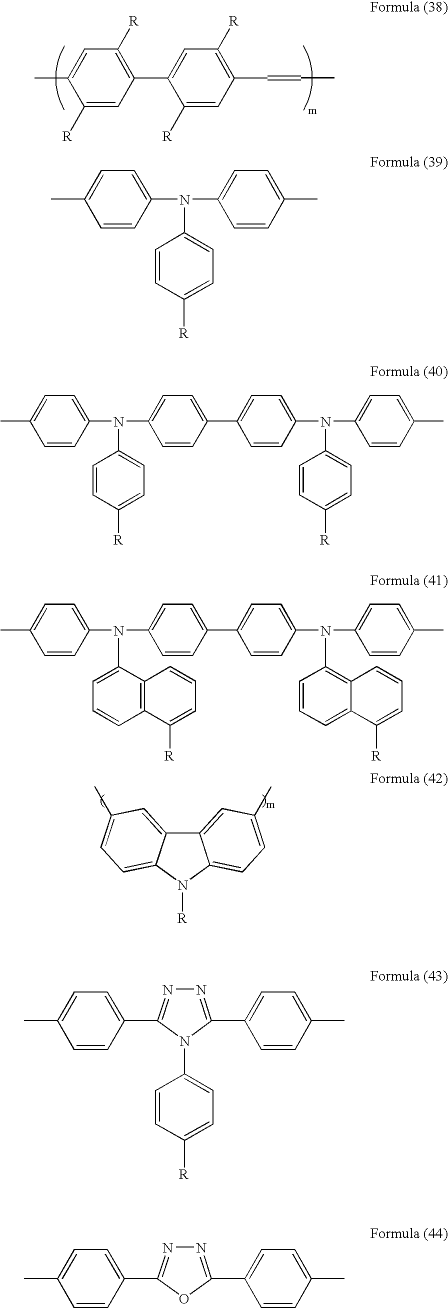

2. The energy-transfer type poly(p-phenylene vinyl) polymeric luminescent material according to claim 1, wherein in formula (1), R₁, R₂, R₃, and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl.

3. The energy-transfer type poly(p-phenylene vinyl) polymeric luminescent material according to claim 1, wherein in formula (2)-formula (29), R₁, R₂, R₃, and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl.

4. The energy-transfer type poly(p-phenylene vinyl) polymeric luminescent material according to claim 1, wherein in formula (30)-formula (44), R₁, R₂, R₃, and R₄ each independently is hydrogen, C1-18 alkyl, C1-18 alkoxy, 4-(N,N′-diphenylamino)phenyl, 4-(N-phenyl-N′-1-naphthylamino)phenyl, 4-[N,N′-di(1-naphthylamino)]phenyl, 4-carbazolylphenyl, phenyl or naphthyl.

5. The energy-transfer type poly(p-phenylene vinyl) polymeric luminescent material according to claim 1, comprising only one kind of luminous element having a content of x and only one kind of luminous element having a content of y.

6. A process for preparing the energy-transfer type poly(p-phenylene vinyl) polymeric luminescent material according to claim 1, comprising the step of copolymerizing at least one Ar₁-containing aromatic dialdehyde monomer represented by general formula (45) and at least one Ar₂-containg aromatic diphosphinium monomer represented by general formula (46) at an equal molar amount, 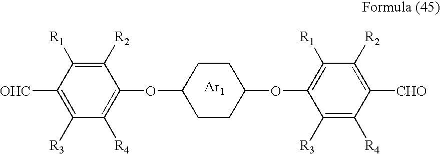
wherein R₁, R₂, R₃ and R₄ each independently is hydrogen, alkyl, alkoxy, optionally substituted phenyl or naphthyl; Ar₁ is defined as in above formula (1); 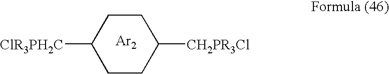
wherein Ar₂ is defined as in above formula (1); R is phenyl, ethyl, ethoxyl, propyl, butyl, pentyl, hexyl or octyl.
